(19) United States
(12) Patent Application Publication
(10) Pub. No.: US 2013/0112912 A1
(43) Pub. Date: May 9, 2013

(54) Lamina-Like Iron Pigments, Magnetorheological Fluid and Device

(71) Applicants: Christian Wolfrum, Erlangen (DE); Stefan Trummer, Nurnberg (DE); Marco Greb, Gelnhausen (DE)

(72) Inventors: Christian Wolfrum, Erlangen (DE); Stefan Trummer, Nurnberg (DE); Marco Greb, Gelnhausen (DE)

(73) Assignee: ECKART GMBH, Hartenstein (DE)

(21) Appl. No.: 13/808,964

(22) PCT Filed: Jul. 5, 2011
(86) PCT No.: PCT/EP2011/061268

§ 371 Date: Jan. 8, 2013

(30) Foreign Application Priority Data
Jul. 9, 2010 (DE) 102010026782.1

(51) Int. Cl. H01F 1/01

(52) U.S. Cl. CPC H01F 1/01
USPC 252/62.55; 428/402

(57) ABSTRACT

The invention relates to lamina-like iron pigments produced by deformation of carbonyl iron powder, the lamina-like iron pigments having a size distribution with a D₅₀ value in a range of from 3 to 16 μm and a size/thickness ratio in a range of from 2 to 50. The invention furthermore relates to a magnetorheological fluid which contains the lamina-like iron pigments according to the invention, as well as to a device which contains the magnetorheological fluid.

The present invention relates to lamina-like iron pigments which are produced by mechanical deformation of carbonyl iron powder, and to the use thereof in a magnetorheological fluid. The invention furthermore relates to a magnetorheological fluid which contains lamina-like iron pigments, as well as to a device which contains the magnetorheological fluid according to the invention.

Magnetorheological fluids (MRF) are suspensions which contain magnetic or magnetizable particles distributed in a carrier fluid, the viscosity of the magnetorheological fluid changing greatly under application of a magnetic field. The viscosity may in this case increase so greatly that the magnetorheological fluid solidifies.

Under the action of a magnetic field on the magnetorheological fluid (MRF), the particles are aligned and form chain structures along the magnetic field line. With a rise in the magnetic field strength, the viscosity of the magnetorheological fluid is increased. When the magnetic field is switched off, the viscosity decreases since the magnetic or magnetizable particles take on a statistical distribution, and the chains formed by the magnetic or magnetizable particles in the fluid are therefore broken down.

Magnetorheological fluids are employed in chassis shock absorbers, seat dampers, motor bearings, four-wheel drive clutches, dampers in bridges or high-rise buildings or, in medical technology, in prostheses.

WO 01/03150 A1 relates to a magnetorheological material which contains a carrier fluid, magnetizable spherical particles having an average diameter of from 0.1 to 1000 μm, and a hydrophobic organomineral clay obtained from bentonite. The hydrophobic organomineral clay is used as an antisettling agent, thickening agent and rheological auxiliary.

U.S. Pat. No. 5,667,715 discloses a magnetorheological fluid in which spherical magnetic particles are dispersed in a fluid, the spherical particles consisting of two groups of particles having different diameter distributions.

European patent EP 0 856 190 B1 discloses a magnetorheological fluid having a component consisting of magnetizable particles which have a partial packing density of at least 0.50 before use in the magnetorheological fluid. In order to achieve this packing density, at least two metal powders which respectively have a partial packing density of less than 0.50 are mixed together. Particle mixtures are thereby obtained which are bimodal, trimodal or multimodal in respect of their particle distribution.

From WO 02/25674 A2, a magnetorheological grease composition is known which, besides magnetizable particles and a carrier fluid, contains from 30 to 90 vol % of thickening agent. The magnetizable particles have a spherical, ellipsoidal or irregular shape, which can be obtained by atomization of molten iron.

European patent EP 0 845 790 B1 discloses magnetorheological fluids which contain magnetizable particles, an oleophilic fluid and optionally a thickening agent, the magnetizable particles first being silanized and then coated with an organic polymer.

The magnetizable particles may be shaped irregularly, or in the form of rods or needles. Preferably, however, the magnetizable particles are spherical.

DE 10 2004 041 651 A1 relates to magnetorheological materials which contain magnetic and nonmagnetic inorganic materials and/or composite particles thereof. The nonmagnetic inorganic materials may in this case be anisotropic particles such as laminae or rods. As laminae, sheet silicates, for example mica, are preferred.

From European patent EP 0 672 294 B1, a magnetorheological material is known, in which the magnetizable particles are freed from contamination products on their surface.

From European patent EP 0 755 563 B1, a magnetorheological material is known, in which the contaminations on the magnetizable particles have not been removed, or not fully removed.

US 2006/0033068 A1 discloses a magnetorheological fluid, the magnetizable particles comprising a group with a low size/thickness ratio of from 1 to less than 1.5, and are therefore spherical, and a second group which has a size/thickness ratio of more than 1.5.

US 2006/0033069 A1 discloses a magnetorheological fluid which contains a multiplicity of magnetizable particles with a low size/thickness ratio having inter-engaging structures. A magnetorheological fluid is furthermore disclosed in which the magnetizable particles comprise a multiplicity of particles with a size/thickness ratio of more than 1.5, the magnetorheological fluid preferably also containing a multiplicity of magnetizable particles having inter-engaging structures with a low size/thickness ratio in a range of from 1 to 1.5.

The previously known magnetorheological fluids disadvantageously require a high magnetizable particle content. Furthermore, it is disadvantageously often necessary for at least two particle distributions to be mixed together in predetermined ratios in order to obtain the required bimodal, trimodal or multimodal size distributions. It is likewise disadvantageous when the particles have to be formed in such a way that they comprise inter-engaging structures. The effect of these properties required according to the prior art is that the production and provision of these magnetorheological fluids is cost-intensive.

Furthermore, there is a need for magnetorheological fluids which have a relaxation time that is as short as possible, i.e. as short as possible a time within which the viscosity decreases after the magnetic field is switched off.

DE 101 14 446 A1 discloses a lamina-like iron pigment which is produced from reductively treated carbonyl iron powder. The lamina-like iron pigment preferably has a particle size in a range of from 6 to 60 μm. The lamina-like iron pigments known from DE 101 14 446 A1 are used as effect pigments in paints and coatings, for plastic colorations, in printing, in cosmetics and as reflector material.

It is an object of the present invention to provide magnetizable particles which, in particular, are suitable for use in magnetorheological fluids. In particular, the magnetizable particles are intended to permit a reduction of the magnetizable particle content while maintaining the magnetic susceptibility in a magnetorheological fluid or, for the same content, to have an increased magnetic susceptibility, so that an equal magnetic field leads to a more pronounced increase in the viscosity. The magnetizable particles are also intended to have a reduced tendency to settling. Furthermore, it is desired to provide a magnetorheological fluid which is distinguished by a relaxation time that is as short as possible.

Usually, the aforementioned effects or parameters influence one another. Often the improvement of one technical application parameter causes a deterioration of another parameter. It is therefore likewise an object of the present invention to provide a magnetorheological fluid which has optimization of the technical application properties mentioned above.

The object of the invention is achieved by providing lamina-like iron pigments which are produced by deformation of carbonyl iron powder, the lamina-like iron pigments having a size distribution with a D₅₀ value in a range of from 3 to 16 μm.

The lamina-like iron pigments obtained by mechanical deformation of carbonyl iron powder are preferably produced as described in DE 101 14 446 A1, the disclosure of which is incorporated here by reference.

In contrast to the teaching of DE 101 14 446 A1, the carbonyl iron powder to be used has an extremely narrow particle size distribution. Thus, the carbonyl iron powder particles to be used have a median particle diameter (D₅₀) in a range of from 1.2 to 5 μm, preferably from 1.5 to 4.5 μm, even more preferably from 1.8 μm to 4.0 μm. A particle size distribution with a median particle diameter (D₅₀) in the range of from 1.9 to 3.8 μm has proven highly suitable.

The carbonyl iron powder is produced by decomposition of iron pentacarbonyl (Fe(CO)₅) in vapor form in cavity decomposers and is commercially available from BASF SE, Ludwigshafen, Germany.

This iron carbonyl powder contains up to 1.5 wt % carbon, about 1 wt % oxygen and up to 1 wt % nitrogen. The iron content is therefore about 96 to 97 wt %. This carbonyl iron powder is preferably subjected to a reductive treatment, for example in a hydrogen flow or in an atmosphere containing hydrogen, by which so-called “reduced carbonyl iron powder” is then obtained, which is distinguished by an iron content of more than wt %, preferably more than 99.5 wt % and a high ductility. This reduced carbonyl iron powder is likewise available on the market, for example from BASF SE, Ludwigshafen, Germany.

The lamina-like iron pigments are produced by deformation, preferably mechanical deformation, of carbonyl iron powder, in particular carbonyl iron powder treated in a reducing atmosphere. The mechanical deformation is conventionally carried out in mills, particularly agitator ball mills, edge mills, cylinder ball mills, rotating tube ball mills, etc.

The mechanical deformation is generally carried out by wet grinding, i.e. by grinding the carbonyl iron powder together with solvent, in particular organic solvent such as white spirit, and in the presence of lubricants or wetting and/or dispersing additives such as oleic acid, stearic acid, etc. The grinding is carried out in the presence of grinding bodies, conventionally grinding balls, the ball diameter usually lying in a range of from 0.5 to 10 mm, preferably from 0.8 to 4.0 mm. The grinding bodies are generally made of ceramic, glass or steel. Steel balls are preferably used as grinding bodies.

In order to obtain the lamina-like iron pigments according to the invention, the carbonyl iron powder used, which is preferably reduced, is preferably size-classified and then mechanically deformed so as to obtain lamina-like iron pigments in a size distribution with a D₅₀ value in a range of from 3 to 16 μm. The classification may for example be carried out with air separators, cyclones, screens and/or other known equipment. The D₅₀ value may be determined by means of laser granulometry, for example with a Cilas 1064 from the company Cilas, France. A D₅₀ value is such that 50% of the particles lie below this value and 50% of all particles lie above this value.

In this method, the metal particles may be measured in the form of a dispersion of particles. The scattering of the incident laser light is detected in different spatial directions and evaluated according to Fraunhofer diffraction theory with the CILAS instrument according to manufacturer specifications. The particles are in this case computationally treated as spheres. The diameters determined therefore always relate to the equivalent sphere diameter averaged over all spatial directions, irrespective of the actual shape of the metal particles. The size distribution is determined, which is calculated in the form of a volume average (in relation to the equivalent sphere diameter). This volume-averaged size distribution may inter alia be represented as a cumulative frequency distribution. The cumulative frequency distribution is in turn usually characterized by certain characteristic values for simplicity, for example the D₅₀ or D₉₀ value. A D₉₀ value means that 90% of all particles lie below the value specified. In other words, 10% of all particles lie above the value indicated. A D₅₀ value is such that 50% of all particles lie below the value indicated and 50% of all particles lie above the value indicated. The cumulative frequency distribution is also referred to as a cumulative undersize curve.

According to another embodiment of the invention, the carbonyl iron powder, in particular the carbonyl iron powder obtained by reductive treatment (“reduced carbonyl iron powder”), can first be ground and then size-classified in order to obtain the lamina-like iron pigments according to the invention having a size distribution with a D₅₀ value in a range of from 3 to 16 μm. The size distribution relates to the diameter of the lamina-like iron pigments.

According to another preferred embodiment, the lamina-like iron pigments have a size/thickness ratio in a range of from 2 to 50, preferably from 3 to 30, more preferably from 4 to 20, even more preferably from 5 to 15. Another more particularly preferred embodiment comprises lamina-like iron pigments with a size/thickness ratio in a range of from 13 to 50. The size/thickness ratio is also referred to as the diameter/thickness ratio.

Astonishingly, the size/thickness ratio for the lamina-like iron pigments according to the invention is very low.

In the case of conventional iron effect pigments, the size/thickness ratio is usually much more than 100. In the case of PVD pigments, the size/thickness ratio typically lies in a range of about 400 or more.

Lamina-like iron pigments which have a size distribution with a D₅₀ value in a range of from 3 to 16 μm and a size/thickness ratio of from 4 to 20 are extremely preferred.

The Inventors have surprisingly established that, by the mechanical deformation of the carbonyl iron powder, the magnetic susceptibility of a magnetorheological fluid which comprises the lamina-like iron pigments obtained by deformation is significantly increased. It is suspected that the mechanical deformation of the carbonyl iron powder, in particular of the carbonyl iron powder treated in the reducing atmosphere, leads to a displacement of the Bloch walls and therefore to a substantial modification of the magnetic domain structure in the lamina-like iron pigment.

Even with minor deformation of the carbonyl iron powder, in particular of the carbonyl iron powder treated in a reducing atmosphere, and therefore with a still low size/thickness ratio, an increase in the magnetic susceptibility normalized to the saturation magnetization (normalized susceptibility) takes place. Astonishingly, the normalized magnetic susceptibility initially increases very strongly in a size/thickness ratio range of from 2 to 20, before flattening off asymptotically.

It has been found that a mechanical deformation of carbonyl iron powder, in particular of carbonyl iron powder treated in a reducing atmosphere, beyond a size/thickness ratio of more than 50 provides no substantial advantage in relation to the normalized magnetic susceptibility of the magnetorheological fluid.

For reasons not yet understood, the increase in the normalized magnetic susceptibility is particularly strong for a size/thickness ratio in the range of from 2 to 30, in particular from 3 to 20.

Since an increased normalized magnetic susceptibility is already obtained with a low size/thickness ratio, the carbonyl iron powder, in particular the carbonyl iron powder treated in a reducing atmosphere, extremely advantageously does not need to be deformed so strongly and can therefore be provided economically and in a short time.

Since the magnetic susceptibility is significantly increased in the case of the lamina-like iron pigments according to the invention, compared with an equal mass of spherical or irregularly shaped iron pigments, less mass of lamina-like iron pigment can be used in order to achieve the same magnetic response behavior of a magnetorheological fluid. When the amount of the lamina-like iron pigment according to the invention, which is the same as the amount of spherical or irregularly shaped carbonyl iron powder, is used in a magnetorheological fluid, a magnetorheological fluid having a substantially stronger magnetic response behavior can be provided.

This result is astonishing and therefore makes it possible to provide substantially improved magnetorheological fluids.

According to another preferred embodiment, the lamina-like iron pigments according to the invention have an edge region which has little roughness, and is preferably not roughened. The edge region of the iron pigments according to the invention is therefore essentially continuous, i.e. has essentially no, and preferably no, indentations or incisions.

According to a preferred variant of the invention, the lamina-like iron pigments have an edge region with a roundedness factor R_{f} according to Formula (I):

$${R}_{f} = \frac{{\sum }_{i = 1}^{N} Equivalent circumference}{{\sum }_{i = 1}^{N} Length of circumferential line} . \qquad ( I )$$

The roundedness factor R_{f} of a particle shape is determined statistically with the aid of image evaluation software (Axiovision 4.6, Zeiss, Germany) using light microscopic and/or SEM images. To this end, the length of the circumferential line is respectively determined from a statistically significant number N of particles. The statistically significant number N of particles is usually about 100. The area is subsequently determined and, from the area, the equivalent circumference of a circle with an equal area is respectively calculated. The arithmetic mean of all the values determined is subsequently determined. The values obtained are put into a ratio according to Formula (I), the number N of particles evaluated being cancelled out and the roundedness factor R_{f} being obtained according to Formula (I). This therefore gives a quantitative measure of the degree of roughening in the edge regions of the particles. Thus, an ideal circular or disk-shaped particle has a roundedness factor R_{f} equal to 1.

The roundedness factor R_{f} of the particles according to the invention preferably lies, in a range of from 0.83 to 0.98, and particularly preferably in a range of from 0.85 to 0.97.

Preferably, the lamina-like iron pigments essentially have no inter-engaging structures in the edge region.

These are to be observed particularly in the case of particles with higher size/thickness ratios, for example for size/thickness ratios >100, which for example have a roundedness factor R_{f}<0.8.

It is in this case advantageous for technical applications that the standard deviation of the roundedness factor for particles with a low size/thickness ratio is less than for those with a high ratio. For particles with size/thickness ratios of more than 100, it lies in the range of plus/minus 10 to 20%, while for the lamina-like iron pigments according to the invention it is preferably from 2 to 8%, and particularly preferably from less than 2.5 to 5%.

The essentially complete absence of inter-engaging structures, i.e. for example indentations and/or incisions, prevents the lamina-like iron pigments according to the invention from being able to form structures in which the iron pigments engage in one another via the peripherally formed structures and, for example, hook onto one another or hook together. This inter-engagement of the laminae may for example occur when an external magnetic field is applied, since, as described, the laminae combine to form chains, and subsequently remains after the external magnetic field is switched off, so that the restoration of the viscosity to the initial level is significantly retarded. This, however, is disadvantageous for technical applications since the relaxation times are relatively long.

The essentially complete absence of inter-engaging structures in the edge region of the lamina-like iron pigments according to the invention is therefore advantageous since the relaxation time tᵣ is shortened by using these lamina-like iron pigments in a magnetorheological fluid.

The relaxation time tᵣ is intended according to the invention to mean the time required for the viscosity to return to the level of the original state (without a magnetic field) after the magnetic field is switched off. As the lamina-like iron pigments of the present invention preferably have no inter-engaging structures in the edge region, the statistical distribution of the lamina-like iron pigments after the magnetic field is switched off takes place in a substantially shorter period of time than is the case when the iron pigments have inter-engaging structures in the edge region and are hooked together.

The Inventors have surprisingly established that the magnetic susceptibility of a magnetorheological fluid is significantly increased by the mechanical deformation of the carbonyl iron powder. It is suspected that the mechanical deformation of the carbonyl iron powder, in particular of the carbonyl iron powder treated in the reducing atmosphere, leads to a displacement of the Bloch walls and therefore to a substantial modification of the magnetic domain structure.

Even with minor deformation of the carbonyl iron powder, in particular of the carbonyl iron powder treated in a reducing atmosphere, and therefore with a still low size/thickness ratio, an increase in the magnetic susceptibility normalized to the saturation magnetization (normalized susceptibility) takes place. Astonishingly, the normalized magnetic susceptibility initially increases very strongly in a size/thickness ratio range of from 2 to 20, before flattening off asymptotically.

It has been found that a mechanical deformation of carbonyl iron powder, in particular of the carbonyl iron powder treated in a reducing atmosphere, beyond a size/thickness ratio of more than 50 provides no substantial advantage in relation to the normalized magnetic susceptibility of the magnetorheological fluid.

For reasons not yet understood, the increase in the normalized magnetic susceptibility is particularly strong for a size/thickness ratio in the range of from 2 to 30, in particular from 3 to 20.

Since an increased normalized magnetic susceptibility is already obtained with a low size/thickness ratio, the carbonyl iron powder, in particular the carbonyl iron powder treated in a reducing atmosphere, extremely advantageously does not need to be deformed so strongly and can therefore be provided economically and in a short time.

Since the magnetic susceptibility is significantly increased in the case of the lamina-like iron pigments according to the invention, compared with an equal mass of spherical or irregularly shaped iron pigments, less mass of lamina-like iron pigment can be used in order to achieve the same magnetic response behavior of a magnetorheological fluid. When the amount of the lamina-like iron pigment according to the invention, which is the same as the amount of spherical or irregularly shaped carbonyl iron powder, is used in a magnetorheological fluid, a magnetorheological fluid having a substantially stronger magnetic response behavior can be provided.

This result is astonishing and therefore makes it possible to provide substantially improved magnetorheological fluids. The magnetorheological fluids according to the invention are characterized in particular by optimization of the parameters base viscosity, magnetic susceptibility and viscosity change in the magnetic field, and the settling behavior of the particles within the fluid. The optimization is in this case characterized by optimal selection of the particle size, size/thickness ratio and morphology of the ground iron particles.

The base viscosity is intended to mean the viscosity which a magnetorheological fluid has without the action of an externally applied magnetic field. The base viscosity is temperature-dependent and may be determined by means of typical rheology methods, for example using a viscometer in a plate/plate configuration.

The magnetic field-induced viscosity is intended to mean the viscosity which a magnetorheological fluid has under the action of an externally applied magnetic field with a defined magnetic field strength. The magnetic field-induced viscosity is likewise temperature-dependent and may be determined by means of special rheology methods, for example using a magnetoviscometer from the company Anton-Paar.

The viscosity change is the difference between the base viscosity and the magnetic field-induced viscosity at a particular temperature and in a defined magnetic field. Preferably, the viscosities measured at a temperature of 40° C. and in a magnetic field of 0 (base viscosity) and up to 1.3 tesla are used as a basis for this.

The magnetic susceptibility of the magnetorheological fluid describes the magnetizability of a magnetorheological fluid in the external magnetic field. The normalized magnetic susceptibility is the magnetic susceptibility of the fluid in relation to the saturation magnetization of the magnetorheological fluid. The saturation magnetization is in this case generally linearly proportional to the mass of magnetizable material in the fluid, so that the effect of the mass of the magnetizable material can be factored out by the normalization for comparison of different magnetorheological fluids.

The settling behavior is intended to mean the tendency of the magnetizable particles in the magnetorheological fluid to settle in the solution and form a sediment under the action of gravity.

Entirely surprisingly, it has been established by the Inventors that it is possible to reduce the magnetizable particle content in a magnetorheological fluid according to the invention in comparison with a magnetorheological fluid which contains substantially spherical carbonyl iron powders (size/thickness ratio <1.5), without loss of the normalized magnetic susceptibility.

This is suspected to be attributable to the increase in the normalized magnetic susceptibility of the magnetorheological fluid according to the invention. This increase is particularly pronounced in the preferred embodiments according to the invention. A further increase in the size/thickness ratio, on the other hand, surprisingly does not lead to a significant further increase in the viscosity change.

When using the same amount of lamina-like iron pigments according to the invention instead of spherical carbonyl iron powder, the normalized magnetic susceptibility is increased greatly, for which reason the viscosity of a magnetorheological fluid can be increased substantially more strongly than is the case when using the same proportion by weight of spherical carbonyl iron powder. This is particularly significant in the case of low magnetic field strengths (<0.6 tesla), which offers significant technical advantages since the generation of low magnetic field strengths can be carried out using small magnetic field coils. Accordingly, the magnetorheological fluids according to the invention have the advantage that a strong viscosity change can be generated using smaller coils. The use of smaller coils, for example in an automobile, gives the advantages that on the one hand they have a lower weight and on the other hand they consume less energy. An economically and ecologically advantageous use is therefore possible.

Another advantage of the iron pigments according to the invention, in comparison with particles with a high size/thickness ratio, resides in the fact that the relaxation time of the inventive embodiment of a magnetbrheological fluid is shortened. When the magnetic field is switched off, the increased viscosity of the magnetorheological fluid induced by the application of the magnetic field is therefore restored to the low-viscosity starting state within a shorter period of time. The lamina-like iron pigments according to the invention therefore make it possible to provide a magnetorheological fluid in which the viscosity is increased within a short period of time and can also be reduced within a short period of time. The magnetic response behavior of a magnetorheological fluid provided by using the lamina-like iron pigments according to the invention is therefore greatly improved, compared with a magnetorheological fluid which contains highly deformed carbonyl iron particles with a high size/thickness ratio. The relaxation behavior of the particles according to the invention is on the one hand similar to the behavior of spherical carbonyl iron powder, but also has the advantage of the significant increase in the magnetic susceptibility.

From the technical requirements of magnetorheological fluids, it is found that they should have a base viscosity which is as low as possible. This has the advantage that a particularly large difference between the viscosity without a magnetic field and that under the action of a magnetic field can be achieved. For technical applications, this viscosity change should be as great as possible so that the greatest possible number of different viscosity ranges can be adjusted by varying the magnetic field. A maximally large scope of the viscosity change increases the technical working range for the corresponding fluids, since the viscosity can be adapted ideally for the different operating states. The spherical magnetizable materials, which are mostly described in the prior art, lead to a relatively small increase in the base viscosity when incorporated into the corresponding carrier fluid. Lamina-like particles, on the other hand, increase the viscosity much more greatly. Accordingly, the increase in the base viscosity for the same proportion by mass is much greater in the case of lamina-like particles than in the case of spherical ones. For magnetorheological fluids, spherical particles are actually to be preferred from this point of view. The advantages when using lamina-like particles are therefore very surprising.

Owing to the lamina-like structure of the iron pigments according to the invention, the settling behavior of the lamina-like iron pigments according to the invention is reduced in comparison with spherical carbonyl iron particles. It has also been found that, in the case of a long idle time of the magnetorheological fluid, the lamina-like iron pigments according to the invention which may have settled can readily be redispersed easily. It is suspected that this easy redispersion behavior is related to the lamina-like structure. Since the lamina-like iron pigments have a statistical orientation in the event of settling, and the lamina planes therefore point in different directions, it is suspected that sufficient carrier fluid is present between the lamina-like iron pigments, for which reason any settled lamina-like iron pigments can easily be redispersed. It is furthermore suspected that, owing to the lower required lamina-like iron pigment content, fewer lamina-like iron pigments also settle and a solid sediment cannot therefore be formed from settled lamina-like iron pigments. Owing to their spherical shape, on the other hand, purely spherical particles can form dense sphere packings which lead to a sediment which is difficult to disperse (agglomerates).

According to a further preferred embodiment, the lamina-like iron pigments have at least one, preferably encapsulating, coating.

The at least one coating may for example be a protective layer against corrosion, which is also referred to as a corrosion protection layer.

The lamina-like iron pigments according to the invention may, for example, be provided with at least one metal oxide layer. Coating with metal oxides, metal hydroxides and/or metal oxide hydrates is preferably carried out by precipitation or by sol-gel methods, or by wet chemical oxidation of the metal surface.

Oxides, hydroxides and/or oxide hydrates of silicon, aluminum, cerium, zirconium, chromium and/or mixtures thereof are preferably used for the metal oxide coating.

According to a preferred refinement, oxides, hydroxides and/or oxide hydrates of silicon and/or aluminum are used. Oxides, hydroxides and/or oxide hydrates of silicon are extremely preferred.

The layer thicknesses of the metal oxide layers, in particular of silicon oxide and/or aluminum oxide layers, lie in the range of preferably from 5 to 150 nm, preferably from 10 to 80 nm, more preferably from 15 to 50 nm.

A protective layer of organic polymers may also be applied as a protective layer against corrosion. Polyacrylate and/or polymethacrylate coatings have proven highly suitable. Of course, it is also possible to use synthetic resin coatings consisting of epoxides, polyesters, polyurethanes, polystyrenes or mixtures thereof.

Instead of or in addition to a coating consisting of metal oxides and/or polymerized synthetic resins, so-called passivation layers may also be applied. The action mechanism of the passivation layers is complex. In the case of inhibitors, it is usually based on steric effects.

The inhibitors are usually added in low concentrations of the order of from 1 wt % to 15 wt %, expressed in terms of the weight of the metal particle used.

The following coating substances are preferably used for the inhibition:
organically modified phosphonic acids or esters thereof of the general formula R—P(O) (OR₁) (OR₂), where: R=alkyl, aryl, alkyl-aryl, aryl-alkyl and alkyl ether, in particular ethoxylated alkyl ether, and R₁, R₂═H, CₙH₂ₙ₊₁, with n=1 to 12, preferably 1-6, in which case alkyl may respectively be branched or unbranched. R₁ may be identical or different to R₂.
organically modified phosphoric acids and esters of the general formula R—O—P(OR₁) (OR₂), with R=alkyl, aryl, alkyl-aryl, aryl-alkyl and of alkyl ether, in particular ethoxylated alkyl ether, and R₁, R₂═H, CₙH₂ₙ₊1, with n=1 to 12, preferably 1-6, in which case alkyl may respectively be branched or unbranched. R₁ may be identical or different to R₂.

Pure inorganic phosphonic acids or esters, or phosphoric acids or esters, or any mixtures thereof, may likewise be used.

The coating may furthermore consist of or comprise organically functionalized silanes, aliphatic or cyclic amines, aliphatic or aromatic nitro compounds, heterocycles containing oxygen, sulfur and/or nitrogen, for example thiourea derivatives, sulfur and/or nitrogen compounds of higher ketones, aldehydes and/or alcohols (fatty alcohols) and/or thiols, or mixtures thereof. The passivating inhibitor layer may, however, also consist of the aforementioned substances. Organic phosphonic acids and/or phosphoric acid esters or mixtures thereof are preferred. When amine compounds are used, they preferably comprise organic radicals having more than 6 C atoms. Aforementioned amines together with organic phosphonic acids and/or phosphoric acid esters or mixtures thereof are preferably used.

The passivation by means of corrosion protection barriers having a chemical and physical protective effect is possible in a variety of ways.

Passivating corrosion protection layers which ensure particularly good corrosion protection for the lamina-like iron pigments comprise or consist of silicon oxide, preferably silicon dioxide, chromium-aluminum oxide, which is preferably applied by chromization methods, chromium oxide, zirconium oxide, cerium oxide, aluminum oxide, polymerized synthetic resin(s), phosphate, phosphite or borate compounds or mixtures thereof.

Silicon dioxide layers and chromium-aluminum oxide layers (chromization) are preferred. Furthermore preferred are cerium oxide, hydroxide or oxide hydrate layers, as well as aluminum oxide, hydroxide or oxide hydrate layers, as described for example in DE 195 20 312 A1.

The SiO₂ layers are preferably produced by sol-gel methods with average layer thicknesses of 10-150 nm and preferably 15-40 nm in organic solvents.

The coatings mentioned above may also be combined, so that for example in a particular embodiment particles according to the invention have a coating consisting of a SiO₂ layer with a subsequently applied layer of functionalized silanes.

The object of the invention is also achieved by providing a magnetorheological fluid which contains the lamina-like iron pigments according to the invention and a carrier fluid.

The fluids and oils conventionally known for magnetorheological fluids may be used as the carrier fluid.

According to a variant of the invention, the carrier fluid is selected from the group consisting of water, water-containing fluids, oil-containing fluids, oil, hydrocarbons, silicones and gels or mixtures thereof.

For example, fatty oils, mineral oils, silicone oils, dicarboxylic acid esters, dicarboxylic acid monoesters, aliphatic alcohols, glycols, diols, water, polyols, neopentyl polyol, neopentyl polyol esters, phosphate esters, saturated and unsaturated hydrocarbons, synthetic paraffins, halogenated hydrocarbons, silicone oils, fluorinated silicones, organically modified silicones and copolymers thereof, polyethers and halogenated derivatives thereof, pentaerythrite, poly-α-olefins or mixtures thereof may be used.

The carrier fluid may in this case be liquid or in gel form.

According to another variant of the invention, without application of a magnetic field, the magnetorheological fluid has a viscosity in the range of from 3 to 1000 mPa·s, preferably from 4 to 800 mPa·s, at a temperature of 40° C. and under a shear rate of 650 s⁻¹, the viscosity being measured as follows: the viscosities may be determined using an Anton-Paar viscometer MCR 301 (Anton Paar, Germany). Measurement is in this case carried out in a suitable sample space depending on the viscosity range [(for example in cylinder geometry (up to 20 mPa·s) and for viscosities of more than 20 mPa·s in ball/plate geometry (20 mm diameter, measurement gap 1 mm). The viscosity is determined with shear rates of between 100 and 1200 1/s at 40° C. by determining the slope of the obtained profile of the shear stress/shear rate function in the range of between 500 and 800 1/s. The profile of the viscosity is in this case determined as a function of the magnetic field strength (between 0 and 1 tesla) and the magnetic field was measured during the measurement by means of a teslameter (Hall probe). The viscosities are particularly preferably measured with magnetic field strengths of 0.1 T and/or 0.3 T and/or 0.6 T and at a temperature of 40° C. This corresponds to very low magnetic field strengths.

The viscosity of the magnetorheological fluid according to the invention is essentially identical, and preferably identical, without application of a magnetic field and after switching off a magnetic field.

According to another preferred embodiment, the magnetorheological fluid contains a proportion of lamina-like iron pigments which lies in a range of from to 90 wt %, more preferably from 30 to 80 wt %, in each case expressed in terms of the total weight of the magnetorheological fluid.

It has surprisingly been found that the iron pigments according to the invention may also be contained in the magnetorheological fluid only in a proportion of from 40 to 70 wt %.

To date, in order to provide magnetorheological fluids it has been necessary for up to 95 wt % of magnetizable particles to be contained.

The present invention therefore makes it possible to provide magnetorheological fluids which contain a substantially lower proportion of magnetizable particles, i.e. lamina-like iron pigments according to the invention. This, as already mentioned above, is possible since the magnetic susceptibility normalized to the mass is significantly increased. The magnetic susceptibility normalized to the mass may, for the lamina-like iron pigment-containing magnetorheological fluid according to the invention, be three to seven times as greater, usually three to five times as greater, compared with the same mass of spherical carbonyl iron particles.

For the same magnetic susceptibility, the proportion by mass of magnetizable particles in the case of using the lamina-like iron pigments according to the invention can therefore be reduced by a factor of from 3 to 7, usually by a factor of from 3 to 5, compared with the use of spherical iron particles. With this reduction of the proportion of magnetizable particles, in view of the density of iron a significant reduction of the overall weight of the magnetorheological fluid is possible. This is a great advantage for many applications. For example, when using the magnetorheological fluid in shock absorbers of a vehicle, the reduced overall weight is a great advantage since the mass, and therefore the fuel consumption, of the vehicle can be reduced overall.

According to another preferred embodiment, the magnetorheological fluid contains no further lamina-like thixotropic agent. The lamina-like iron pigments according to the invention themselves already act as a thixotropic agent in the magnetorheological fluid. Further addition of lamina-like thixotropic agents, for example mica or kaolin, can therefore be obviated, which leads to a simplification of the formulation.

With an increased magnetizable particle content, in the case of conventional magnetorheological particles significant settling of the magnetizable particles also takes place in view of the spherical structure of the particles, which then also form a sediment of settled magnetizable particles which is more difficult to redisperse owing to the high magnetizable particle content.

In order to achieve a reduction in the sedimentation of magnetizable particles in the prior art, thixotropic agents are conventionally added.

Thixotropic agents also disadvantageously increase the basic viscosity, i.e. the viscosity which exists when a magnetic field is not applied or when a magnetic field is switched off. The difference in viscosity existing when a magnetic field is applied and when a magnetic field is switched off is therefore disadvantageously reduced.

In the variant according to the invention in which no thixotropic agent needs to be added in the magnetorheological fluid, the difference between the viscosity when a magnetic field is applied and when a magnetic field is absent or switched off is greater.

With the magnetorheological fluid according to the invention, the viscosity of the magnetorheological fluid can therefore be varied over a larger range and also more finely as a function of the strength of the applied magnetic field. This is a great advantage in application.

According to another preferred embodiment, the proportion of carrier fluid lies in a range of from 2 to 70 wt %, more preferably from 3 to 60 wt %, in a particularly preferred variant from 5 to 50 wt %, in each case expressed in terms of the total weight of magnetorheological fluid.

As already mentioned above, one great advantage of the magnetorheological fluid according to the invention resides in the fact that the increased-viscosity state induced by the magnetization is converted rapidly into a low-viscosity state after the magnetic field is switched off. The magnetorheological fluid of the present invention therefore permits rapid switching on and off, the viscosity correspondingly being increased or reduced again rapidly. The present invention therefore makes it possible to provide a magnetorheological fluid having a rapid response behavior.

The magnetorheological fluid may optionally also contain additives. For example, dyes or pigments, abrasive particles, lubricants, antiwear agents, antioxidants, pH regulators, salts, neutralizing agents, antifoaming agents, corrosion inhibitors, corrosion protection agents, antisettling agents, dispersants etc. may also be contained the magnetorheological fluid.

Even though no thixotropic additive, preferably no lamina-like thixotropic additive, needs to be added in the case of the magnetorheological fluid according to the present invention, it is of course possible to also add one or more thixotropic additives.

These optional additives are preferably used in an amount of from 0.01 to 20 wt %, more preferably from about 0.1 to 15 wt %, even more preferably from 0.5 to about 10 wt %, in each case expressed in terms of the total weight of the magnetorheological fluid. An amount of additive from about 1 wt % to about 6 wt % has also proven highly suitable.

A magnetorheological fluid according to the invention preferably contains dispersing additives selected from the group of dispersing additives based on usual cationic, nonionic or preferably anionic surfactants, for example, carboxylates, sulfonates or phosphonates of hydrocarbons. In a particularly preferred embodiment, the use in particular of alkyl or aryl compounds, long-chain carboxylic acids such as fatty acids, for example with chain lengths C6-C24, carboxylates derived therefrom or dispersants based on acid esters such as alkyl- or arylcarboxylic acid esters, alkylphosphoric or alkylphosphonic acid esters, long-chain alcohols or alcohol ethoxylates is employed.

If polymeric dispersing additives are used, then the use of the classes of fatty acid chemistry, polyesters, polyamine amides, Diels-Alder adducts, phosphoric acid esters of the classes polyester/polyether polymers, polyether polymers, additives of the class of polyurethanes, polyether urethanes or polyester urethanes and polyamino compounds and based on polyacrylates.

Such polymeric dispersing additives are available, for example, under the name BYK® (company BYK-Chemie).

The dispersing additives may be added to the magnetorheological formulation on the one hand during the mixture preparation and/or already to the grinding process of the lamina-like iron particles according to the invention.

The aforementioned dispersants both permit dispersion during the grinding process and in this case act as grinding auxiliary in order to prevent aggregation of the lamina-like particles obtained. Besides dispersing the particles, the dispersing additives within the magnetorheological fluid according to the invention also ensure good redispersibility after possible sedimentation of the particles. Furthermore, the use of dispersing additives ensures a good flow behavior of the magnetorheological formulation in different temperature ranges, so that for example the flow behavior is provided at low temperatures.

The dispersing additives optionally to be added improve the redispersibility after any sedimentation of the lamina-like iron pigments. In the case of dispersing auxiliaries, even smaller amounts are sufficient. The dispersing additives are in the formulation according to the invention preferably in an amount of from 0.01 to 15 wt %, particularly preferably from 0.05 to 10 wt %, in particular from 0.1 to 5 wt %, in each case expressed in terms of the total weight of magnetorheological fluid.

If thixotropic additives are added, settling in the fluid of the magnetizable particles used can be further influenced. Thixotropic additives based on modified ureas, high molecular weight urea-modified polyamides and acrylate thickeners based on polyacrylates, such as are marketed under the name BYK® (company BYK Chemie GmbH), are preferred according to the invention. Besides this, particulate additives such as metal oxides such as titanium dioxides, aluminum oxides, iron oxides, silicon dioxide and/or highly disperse silica may be added, for example fumed silica under the name Aerosil (company Degussa). Synthetic or natural lamina-like sheet silicates, for example mica, kaolin, bentonites, hectorites or smectites, or for example hydrophobically or organically modified variants thereof, may furthermore be added to the magnetorheological fluid. These are known under the name Bentone® (company Elementis). The thixotropic additives may be used in the present embodiment of the invention preferably in an amount of from 0.01 to 15 wt %, particularly preferably from 0.01 to 10 wt %, in particular from 0.1 to 5 wt %.

In a particularly preferred variant, on the other hand, no further lamina-like thixotropic additives are contained in the magnetorheological fluid since a good settling behavior is already obtained owing to the lamina-like shape of the particles according to the invention.

For example, PTFE powder, molybdenum sulfide and/or graphite powder may be used as lubricants.

The object of the invention is furthermore achieved by use of the lamina-like iron pigments according to the invention for the production of a magnetorheological fluid.

The object of the invention is also achieved by provision of a device which contains a magnetorheological fluid according to the invention.

Preferably, the device according to the invention is selected from the group consisting of brakes, dampers, clutches, bearings, steering systems, seals, prostheses and actuators.

The invention will be illustrated in more detail below with the aid of figures and examples, without being restricted thereto.

### FIGURES

FIG. 1 shows the influence of the size/thickness ratio on the normalized magnetic susceptibility.

FIG. 2 shows lamina-like magnetic particles according to the invention with a size/thickness ratio of 20:1 according to Example 3.

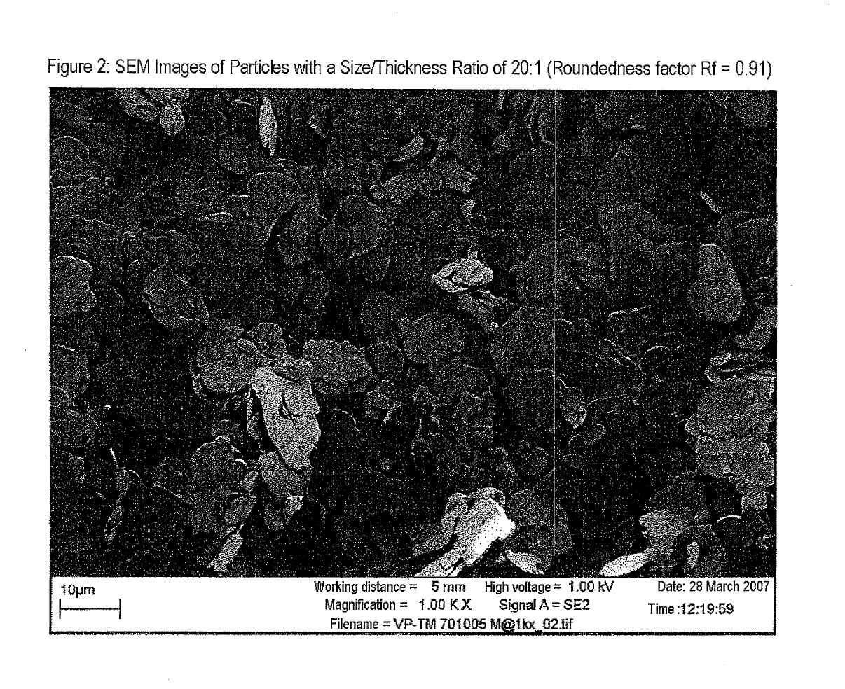

FIG. 3 shows lamina-like magnetic particles with a size/thickness ratio of 200:1 according to Comparative Example 8.

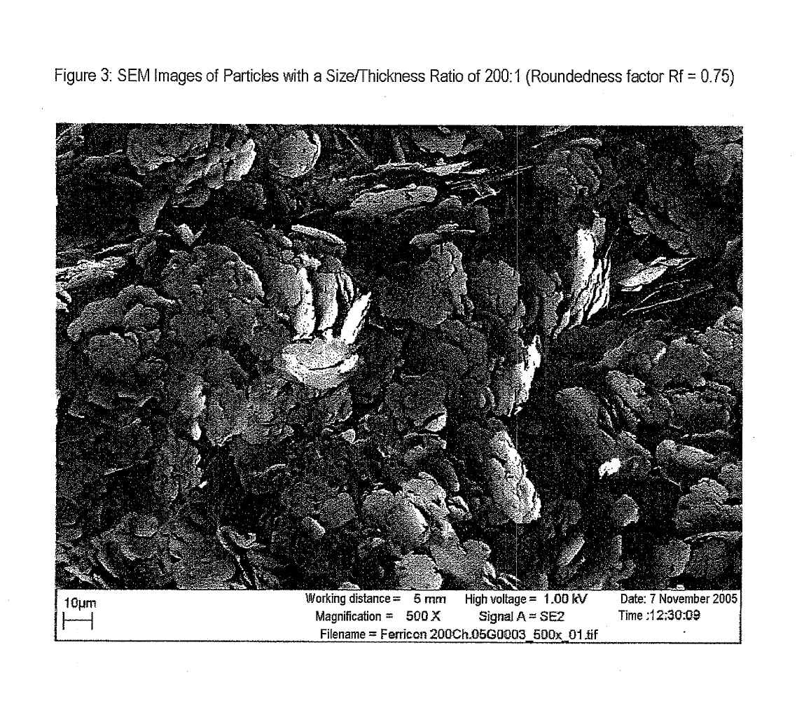

FIG. 4 shows the dependency of the viscosity on the size/thickness ratio of the particles in different magnetic fields.

### EXAMPLES

### I Measurement Methods

### Size/Thickness Ratio:

The size/thickness ratio of a particle sample from the examples mentioned was determined by the evaluation of SEM images. In this case, the long diameter, by means of Cilas 1064, and the thickness of a statistical number of particles (at least 100) were respectively determined and the average size/thickness ratio was calculated by forming the ratio of long diameter to thickness.

### Viscosities:

The viscosities were determined using an Anton-Paar viscometer MCR 301 (Anton Paar, Germany). To this end, the required amount of the corresponding fluid was put into the sample space suitable for the respective viscosity range (about 40 g in cylinder geometry (up to 20 mPa·s) and 3 g in ball/plate geometry (more than 20 mPa·s), and the viscosity was measured by means of a suitable measurement protocol. The determination of the neutral viscosity was carried out with shear rates of between 100 and 1200 1/s at 40° C. by determining the slope of the obtained profile of the shear stress/shear rate function in the range of between 500 and 800 1/s. The determination of the magnetic field-induced viscosity was carried out in a special measurement cell (MRD 180/1T [Anton Paar, Germany]) with a plate/plate geometry (20 mm diameter, measurement gap 1 mm). 3 g of the fluid were introduced and the profile of the viscosity as a function of the magnetic field strength (between 0 and 1 tesla) was determined. The magnetic field was measured during the measurement by means of a teslameter (Hall probe), which was arranged directly under the measurement cell.

### Magnetic Susceptibility:

The determination of the normalized magnetic susceptibility was carried out in a magnetometer (Vibrating Sample Magnetometer Lake Shore 7407 [Lake Shore Cryotronics, Inc, Westerville, Ohio, USA). To this end, 1 g of the fluid was put into the sample space and the sample was subsequently measured using standard protocols from the manufacturer. The evaluation was carried out by plotting the function M(H). The initial susceptibility was determined as the slope of the function in the linear range. This value was subsequently set in relation to the saturation magnetization. The saturation magnetization was determined as the value of H=infinite by linear extrapolation of the function M(1/H).

### Settling Behavior:

The formulations were respectively introduced into a test tube with a filling level of 8 cm, and after 3 h the height of the clear liquid supernatant as a percentage of the total filling level was determined.

### Roundedness Factor:

The roundedness factor R_{f} of a particle shape was determined statistically with the aid of image evaluation software using light microscopic and/or SEM images. To this end, the length of the circumferential line was respectively determined from a statistically significant number of particles, usually 100 particles. The area was subsequently determined and the equivalent circumference of a circle of equal area was respectively calculated from the area. The arithmetic mean of all values determined was subsequently determined. The values obtained were set into a ratio according to Formula (I) and the roundedness factor R_{f} was obtained.

### II Production

### Example 1

### Production of Lamina-Like Iron Pigments by Grinding

A mixture of 50 g carbonyl iron powder SQ (median particle size D₅₀=3.6 μm, iron content >99.5%, company BASF AG) and 150 g of white spirit as well as 0.9 g of oleic acid as a dispersing and grinding agent were introduced into a pot mill (length: 32 cm, width: 19 cm) together with 2 kg of steel balls (diameter: 1.5 mm) and ground at 45 rpm for 1 h. The grinding product removed from the mill was washed with white spirit and separated from the grinding balls by means of screening (40 μm). The white spirit was substantially removed from the screened fraction by means of a nutsche filter. The filter cake obtained was isolated with a solids content of 90 wt %.

The lamina-like iron pigments obtained had an average size/thickness ratio of 10 (determined from a statistical calculation using SEM images) and a median particle size D₅₀=10.1 μm (CILAS). Particles with other size/thickness ratios (for the examples mentioned below) were produced by varying the grinding time with otherwise identical test parameters.

### Example 2

### Magnetorheological Fluid

In order to produce 80 g of a magnetorheological fluid according to the invention with a proportion by weight of 50 wt %, 44.4 g of a 90 wt % paste of lamina-like iron particles in white spirit with an averaged size/thickness ratio of 45 (median particle size D₅₀=13.2 μm, CILAS, obtained according to the method described in Example 1) were weighed into a 250 ml aluminum beaker and 35.6 g of the carrier oil consisting of paraffin oil (Enerpar M 1930, viscosity mPa·s at 40° C., company BP, UK) were subsequently dispersed in with a stirring mechanism by using a dissolver disk (disk diameter 3 cm) at 3000 rpm for 5 min.

### Example 3

### Magnetorheological Fluid

In order to produce 80 g of a magnetorheological fluid according to the invention with a proportion by weight of 50 wt %, the method was carried out in a similar way to Example 2:
magnetizable particles: 44.4 g of lamina-like iron particles in the form of a 90 wt % white spirit paste with an averaged size/thickness ratio of 20 (SEM) and median particle size D₅₀=12.3 μm (CILAS) obtained by grinding in a similar way to Example 1
carrier oil: 35.6 g of the carrier oil consisting of paraffin oil (Enerpar M 1930, viscosity 95 mPa·s at 40° C., company BP, UK).

### Example 4

### Magnetorheological Fluid

In order to produce 80 g of a magnetorheological fluid according to the invention with a proportion by weight of 50 wt %, operation was carried out in a similar way to Example 2:
magnetizable particles: 44.4 g of lamina-like iron particles in the form of a 90 wt % white spirit paste with an averaged size/thickness ratio of 10 (SEM) and median particle size D₅₀=7.9 μm (CILAS) obtained by grinding in a similar way to Example 1
carrier oil: 35.6 g of the carrier oil consisting of paraffin oil (Enerpar M 1930, viscosity 95 mPa·s at 40° C., company BP, UK).

### Example 5

### Magnetorheological Fluid

In order to produce 80 g of a magnetorheological fluid according to the invention with a proportion by weight of 50 wt %, operation was carried out in a similar way to Example 2:
magnetizable particles: 44.4 g of lamina-like iron particles in the form of a 90 wt % white spirit paste with an averaged size/thickness ratio of 5 (SEM) and median particle size D₅₀=6.6 μm (CILAS) obtained by grinding in a similar way to Example 1
carrier oil: 35.6 g of the carrier oil consisting of paraffin oil (Enerpar M 1930, viscosity 95 mPa·s at 40° C., company BP, UK).

### Example 6 (Comparative Example)

### Magnetorheological Fluid

In order to produce 80 g of a magnetorheological fluid as a comparative example with a proportion by weight of 50 wt %, operation was carried out in a similar way to Example 2:
magnetizable particles: 40 g of spherical iron particles with a size/thickness ratio of 1 and a particle size D₅₀=3.6 mm (CILAS) [carbonyl iron powder SQ, (company BASF SE)]
carrier oil: 40 g of the carrier oil consisting of paraffin oil (medicinal white oil: Enerpar M 1930, viscosity 95 mPa·s at 40° C., company BP, UK).

### Example 7 (Comparative Example)

### Magnetorheological Fluid

In order to produce 80 g of a magnetorheological fluid according to the invention with a proportion by weight of 50 wt %, operation was carried out in a similar way to Example 2:
magnetizable particles: 44.4 g of lamina-like iron particles in the form of a 90 wt % white spirit paste with an averaged size/thickness ratio of 80 (SEM) and median particle size D₅₀=14.5 μm (CILAS) obtained by grinding in a similar way to Example 1
carrier oil: 35.6 g of the carrier oil consisting of paraffin oil (Enerpar M 1930, viscosity 95 mPa·s at 40° C., company BP, UK).

### Example 8 (Comparative Example)

### Magnetorheological Fluid

In order to produce 80 g of a magnetorheological fluid with a proportion by weight of 50 wt %, operation was carried out in a similar way to Example 2:
magnetizable particles: 44.4 g of lamina-like iron particles in the form of a 90 wt % white spirit paste with an averaged size/thickness ratio of 200 (SEM) and median particle size D₅₀=19.1 μm (CILAS) obtained by grinding in a similar way to Example 1
carrier oil: 35.6 g of the carrier oil consisting of paraffin oil (Enerpar M 1930, viscosity 95 mPa·s at 40° C., company BP, UK).

### Example 9

### Magnetorheological Fluid

In order to produce 80 g of a magnetorheological fluid according to the invention with a proportion by weight of 50 wt %, 44.4 g of a 90 wt % paste of lamina-like iron particles in white spirit with an averaged size/thickness ratio of 10 (median particle size D₅₀=7.9 μm, CILAS, obtained in a similar way to the method described in Example 1) were weighed into a 250 ml aluminum beaker and 35.6 g of the carrier oil consisting of the dicarboxylic acid ester butyl benzyl phthalate (viscosity 40 mPa·s at 40° C., Chemos GmbH) were subsequently dispersed in with a stirring mechanism by using a dissolver disk (disk diameter 3 cm) at 3000 rpm for 5 min.

### Example 10

### Magnetorheological Fluid

In order to produce 80 g of a magnetorheological fluid according to the invention with a proportion by weight of 50 wt %, 44.4 g of a 90 wt % paste of lamina-like iron particles in white spirit with an averaged size/thickness ratio of 10 (median particle size D₅₀=7.9 μm, CILAS, obtained in a similar way to the method described in example Example 1) were weighed into a 250 ml aluminum beaker and 35.6 g of the carrier oil consisting of the poly-α-olefin Durasyn 164 (viscosity 11.6 mPa·s at 40° C., BP Amoco, UK) were subsequently dispersed in with a stirring mechanism by using a dissolver disk (disk diameter 3 cm) at 3000 rpm for 5 min.

### Example 11

### Magnetorheological Fluid

In order to produce 80 g of a magnetorheological fluid according to the invention with a proportion by weight of 50 wt %, 44.4 g of a 90 wt % paste of lamina-like iron particles in white spirit with an averaged size/thickness ratio of 10 (median particle size D₅₀=7.9 μm, CILAS, obtained in a similar way to the method described in example Example 1) were weighed into a 250 ml aluminum beaker and 35.6 g of the carrier oil consisting of the paraffin oil Nexbase 3020 (viscosity 50 mPa·s at 40° C., Fortum Corporation, Finland) were subsequently dispersed in with a stirring mechanism by using a dissolver disk (disk diameter 3 cm) at 3000 rpm for 5 min.

### Example 12

### Magnetorheological Fluid

In order to produce 80 g of a magnetorheological fluid according to the invention with a proportion by weight of 50 wt %, 44.4 g of a 90 wt % paste of lamina-like iron particles in white spirit with an averaged size/thickness ratio of 10 (median particle size D₅₀=7.9 μm, CILAS, obtained in a similar way to the method described in example Example 1) were weighed into a 250 ml aluminum beaker and 35.6 g of the carrier oil consisting of the poly-α-olefin Synfluid (viscosity 51 mPa·s at 40° C., ChevronPhillips Chemical Company, USA) were subsequently dispersed in with a stirring mechanism by using a dissolver disk (disk diameter 3 cm) at 3000 rpm for 5 min.

### Example 13

### Magnetorheological Fluid

In order to produce 80 g of a magnetorheological fluid according to the invention with a proportion by weight of 75 wt %, 66.6 g of a 90 wt % paste of lamina-like iron particles in white spirit with an averaged size/thickness ratio of 10 (median particle size D₅₀=7.9 μm, CILAS, obtained in a similar way to the method described in example Example 1) were weighed into a 250 ml aluminum beaker and 11.4 g of the carrier oil consisting of the dicarboxylic acid ester butyl benzyl phthalate (viscosity 40 mPa·s at 40° C., Chemos GmbH) were subsequently dispersed in, with the addition of 2.0 g of the thixotropic additive BYK 411 (BYK-Chemie, Germany) with a stirring mechanism by using a dissolver disk (disk diameter 3 cm) at 3000 rpm for 5 min.

| | | | | Magnetic | | | | |
|---|---|---|---|---|---|---|---|---|
| | | | | field- | | | | |
| | | | | induced | | | | |
| | | | | viscosity | | | | |
| | | | | at 40° C. | Magnetic field- | | | |
| | | | | with | induced | Magnetic field- | | |
| | | | | magnetic | viscosity | induced | | |
| | | | | field | at 40° C. with | viscosity | | |
| | | | Base viscosity | 0.1 T | magnetic field | at 40° C. with | | |
| | | | at 40° C. with | and | 0.3 T | magnetic field | | Settling |
| | Particle | | shear rate 650 | shear rate | and shear rate | 0.6 T and shear rate | Normalized | behavior |
| | size/thickness | Roundedness | 1/s | 100 s⁻¹ | 100 s⁻¹ | 100 s⁻¹ | magnetic | after 3 h |
| Example | ratio | factor R_{f} | [mPa · s] | [mPa · s] | [mPa · s] | [mPa · s] | susceptibility χ | [%] |
| 2 | 45 | 0.85 | 17.3 | 2174 | 5531 | 6266 | 25.3 × 10⁻³ | 8 |
| 3 | 20 | 0.89 | 15.2 | 1720 | 5033 | 6089 | 23.1 × 10⁻³ | 12 |
| 4 | 10 | 0.91 | 10.6 | 1585 | 5010 | 6073 | 18.1 × 10⁻³ | 15 |
| 5 | 5 | 0.93 | 10.2 | 1301 | 4778 | 5985 | 12.2 × 10⁻³ | 20 |
| 6 | 1 | 1 | 17.9 | 705 | 4290 | 5798 | 6.0 × 10⁻³ | 33 |
| (Comparative) | | | | | | | | |
| 7 | 80 | 0.78 | 250 | 2554 | 5911 | 6375 | 27.2 × 10⁻³ | 3 |
| (Comparative) | | | | | | | | |
| 8 | 200 | 0.75 | too viscous | too viscous | too viscous | too viscous | too viscous | 1 |
| (Comparative) | | | | | | | | |
| 9 | 10 | 0.91 | 6.2 | 1320 | 4999 | 5996 | 19.5 × 10⁻³ | 17 |
| 10 | 10 | 0.91 | 7.9 | 1333 | 4857 | 6043 | 19.4 × 10⁻³ | 20 |
| 11 | 10 | 0.91 | 5.8 | 1378 | 4922 | 6021 | 18.6 × 10⁻³ | 13 |
| 12 | 10 | 0.91 | 5.5 | 1341 | 4899 | 6024 | 18.9 × 10⁻³ | 12 |
| 13 | 10 | 0.91 | 56.5 | 2488 | 19490 | 40250 | 20.1 × 10⁻³ | 5 |

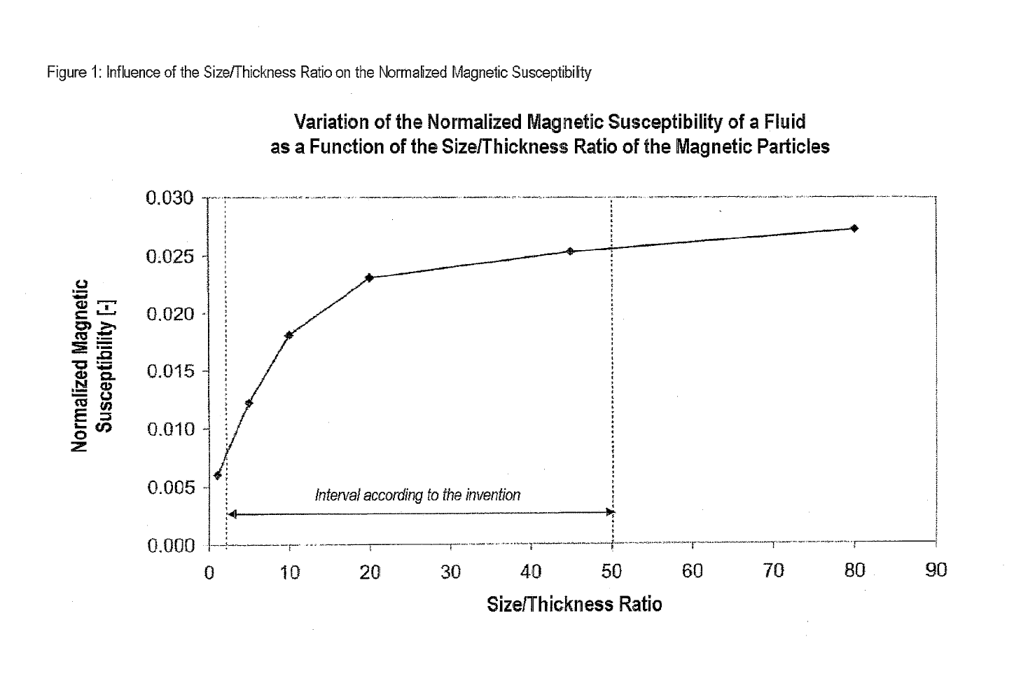

The advantage of the invention is very clear from the examples mentioned in Table 1. The normalized magnetic susceptibility of Comparative Example 6 is 6.0×10⁻³. Examples 2 to 5 show that the susceptibilities rise greatly with an increasing size/thickness ratio. In comparison with Comparative Example 6, the susceptibility in Example 2 is increased by a factor of 4. However, the increase in the susceptibility turns out to be small in even larger size/thickness ratios. For instance, the susceptibility of Example 7 is only slightly greater than that of Example 2. Accordingly, it is not expedient to increase the size/thickness ratio beyond the range according to the invention. The increase in the susceptibility is particularly pronounced in Examples 3-5, which can explain the size/thickness ratios particularly preferred in the invention. The described profile is clearly discernible in FIG. 1.

As confirmed by way of example by Examples 2-5 according to the invention in comparison with Comparative Example 6, the size/thickness ratio according to the invention significantly improves the settling behavior of magnetorheological formulations. The particles settle significantly less owing to their lamina-like shape.

Although particles with size/thickness ratios which are higher than the ratios according to the invention do have a further improved settling behavior, the viscosity of such formulations is already very high without an applied magnetic field (base viscosity), so that the viscosity change due to application of a magnetic field turns out to be only small. Accordingly, particles with such high size/thickness ratios are technically unusable, or usable only with great disadvantage.

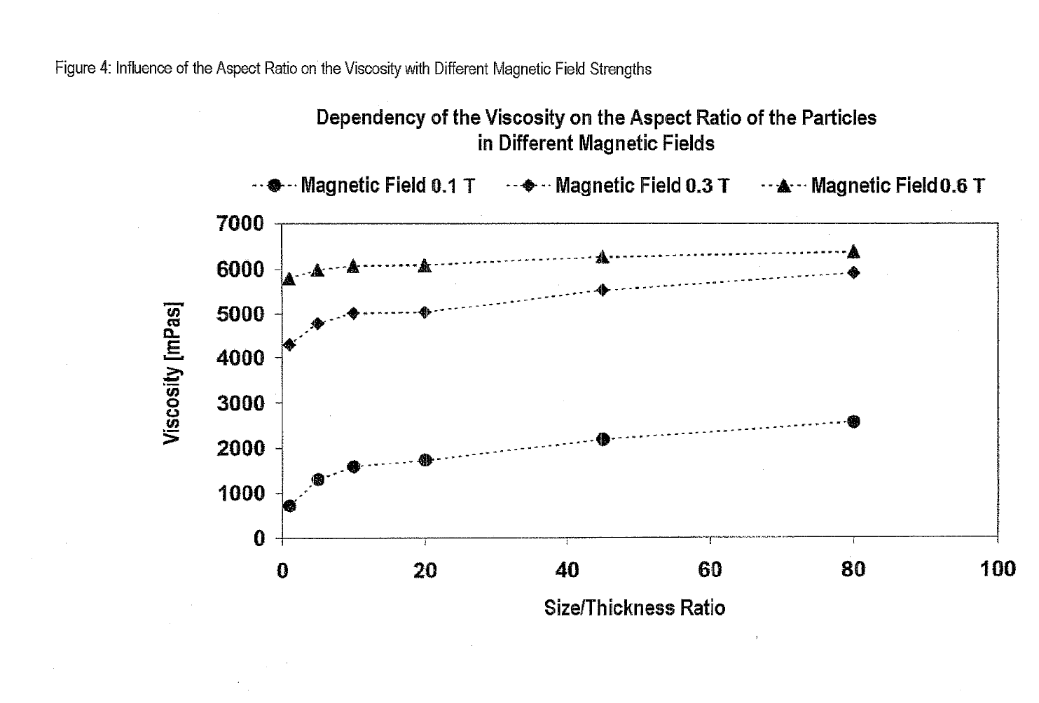

Another advantage of the size/thickness ratios according to the invention is shown in FIG. 4. In small magnetic fields, the particles already exhibit a significant increase in the viscosity in comparison with the base viscosity.

1. Lamina-like iron pigments produced by deformation of carbonyl iron powder,
wherein
the lamina-like iron pigments have a size distribution with a D₅₀ value in a range of from 3 to 16 μm and a size/thickness ratio in a range of from 2 to 50.

2. The lamina-like iron pigments as claimed in claim 1,
wherein
the lamina-like iron pigments have a size/thickness ratio in a range of from 3 to 30.

3. The lamina-like iron pigments as claimed in claim 1,
wherein
the lamina-like iron pigments have an edge region with a roundedness factor according to Formula (I):
$${R}_{f} = \frac{{\sum }_{i = 1}^{N} Equivalent circumference}{{\sum }_{i = 1}^{N} Length of circumferential line} , \qquad ( I )$$
the roundedness factor preferably lying in a range of from 0.83 to 0.98.

4. The lamina-like iron pigments as claimed in claim 1,
wherein
the lamina-like iron pigments essentially have no inter-engaging structures in the edge region.

5. The lamina-like iron pigments as claimed in claim 1,
wherein
the lamina-like iron pigments comprise at least one coating.

6. A magnetorheological fluid
comprising lamina-like iron pigments as claimed in claim 1 and a carrier fluid.

7. The magnetorheological fluid as claimed in claim 6,
wherein
the proportion of lamina-like iron pigments lies in a range of from 25 to 90 wt %, expressed in terms of the total weight of the magnetorheological fluid.

8. The magnetorheological fluid as claimed in claim 6,
wherein
the magnetorheological fluid contains no further lamina-like thixotropic agents.

9. The magnetorheological fluid as claimed in claim 6,
wherein
the carrier fluid is selected from the group consisting of water, water-containing fluids, oil-containing fluids, oil, hydrocarbons, silicones and mixtures thereof.

10. The magnetorheological fluid as claimed in claim 6,
wherein
the proportion of carrier fluid lies in a range of from 2 to 70 wt %, expressed in terms of the total weight of magnetorheological fluid.

11. The magnetorheological fluid as claimed in claim 6,
wherein
without application of a magnetic field, the magnetorheological fluid has a viscosity in the range of from 3 to 1000 Pa·s at a temperature of 40° C. with a shear rate of 650 s⁻¹, the viscosity being determined using an Anton-Paar viscometer MCR 301 (Anton Paar, Germany), a cylinder geometry being measured as the sample space in a viscosity range of up to 20 mPa·s and in a ball/plate geometry (20 mm diameter, measurement gap 1 mm) for viscosities of more than 20 mPa·s.

12. (canceled)

13. A device
comprising the magnetorheological fluid as claimed in claim 6.

14. The device as claimed in claim 13,
wherein
the device is selected from the group consisting of brakes, dampers, clutches, bearings, steering systems, seals, prostheses and actuators.

15. A process for producing a magnetorheological fluid, comprising combining lamina-like iron pigments according to claim 1 with a carrier fluid to form a magnetorheological fluid.

16. The lamina-like iron pigments according to claim 5, wherein the at least one coating is an encapsulating coating.

17. The lamina-like iron pigments according to claim 5, wherein the at least one coating is selected from the group consisting of metal oxide layer, organic polymer layer, passivation substance, and mixtures thereof.

18. The lamina-like iron pigments according to claim 17, wherein the at least one metal oxide layer comprises at least one metal oxide selected from the group consisting of metal oxides, metal hydroxides, metal oxide hydrates, and mixtures thereof.

19. The lamina-like iron pigments according to claim 17, wherein the at least one metal oxide layer comprises at least one metal selected from the group consisting of silicon, aluminum, cerium, zirconium, chromium, and mixtures thereof.

20. The lamina-like iron pigments according to claim 5, wherein the at least one coating comprises at least one organically functionalized silane, aliphatic or cyclic amine, aliphatic or aromatic nitro compound, heterocycle containing oxygen, sulfur and/or nitrogen, sulfur compound of higher ketone, nitrogen compound of higher ketone, aldehyde, alcohol, thiol, organic phosphonic acid, phosphoric acid ester and mixtures thereof.
